(19) United States
(12) Patent Application Publication
(10) Pub. No.: US 2024/0283568 A1
(43) Pub. Date: Aug. 22, 2024

(54) A METHOD TO FACILITATE ADAPTIVE BIT LOADING BY INSERTION OF DUMMY BITS PRIOR TO INTERLEAVING

(71) Applicant: SIGNIFY HOLDING B.V., EINDHOVEN (NL)

(72) Inventors: ROBERT JAMES DAVIES, EINDHOVEN (NL); NANCY YUSHAN LEE, EINDHOVEN (NL); ANDRIES VAN WAGENINGEN, WIJLRE (NL); MATTHIAS WENDT, WÜRSELEN (DE)

(21) Appl. No.: 18/569,311

(22) PCT Filed: Jun. 16, 2022
(86) PCT No.: PCT/EP2022/066473

§ 371 Date: Dec. 12, 2023

(30) Foreign Application Priority Data
Jun. 18, 2021 (EP) 21180186.5
Aug. 3, 2021 (EP) 21189358.1

(51) Int. Cl. H04L 1/00

(52) U.S. Cl. CPC H04L 1/0071; H04L 1/0003

(57) ABSTRACT

A method (500) for facilitating adaptive bit loading in a transmitter (200) of a multi-carrier communication system (100) comprising a plurality of subcarriers, the method (500) comprising the transmitter (200) performing the steps of: determining (S501) an adaptive bit loading profile; wherein the adaptive bit loading profile defines for each one out of the plurality of subcarriers a corresponding constellation, and more than one constellation are to be used by the plurality of subcarriers; determining (S502) a size of an interleaving template table according to the highest order constellation of the determined adaptive bit loading profile; preparing (S503) data blocks by filling in data bits of an encoded data stream to the interleaving template table according to a predefined pre-processing pattern; wherein the predefined pre-processing pattern defines whether a cell in the interleaving template table is to be filled in either by a data bit of the encoded data stream or a dummy bit; carrying out (S504) an interleaving operation on the prepared data blocks; selecting (S505) bits from the interleaved data blocks according to a predefined selection pattern for mapping the selected bits to the more than one constellation of the plurality of subcarriers, wherein the predefined-selection pattern corresponds to the predetermined pre-processing pattern such that a data bit is selected, and a dummy bit is discarded.

### FIELD OF THE INVENTION

The invention relates to the field of physical (PHY) layer processing control in a multi-carrier wireless communication system. More particularly, various methods, apparatus, systems, and computer-readable media are disclosed herein related to enabling adaptive bit loading in conventional multi-carrier systems without that feature.

### BACKGROUND OF THE INVENTION

In an optical wireless communication (OWC) system, such as a LiFi system, an optical emitter, typically an LED or a laser-based device, is modulated in order to convey data to an optical receiver, which is typically based on a photodiode followed by a matched transimpedance amplifier. The signals in such a system may be modulated according to existing communication standards, such as a member of the IEEE 802.11 family of wireless LAN standards or the ITU G.996x/G.9991 series of recommendations for in-home network.

To support high data rate communication, such standards define channels with bandwidths in an order of tens or even hundreds of MHz. Furthermore, orthogonal frequency division multiplexing (OFDM) with a high-order modulation scheme is used on each subcarrier.

A challenge with the re-use of such standards for OWC is that the bandwidth of the emitter and/or the photodetector may be limited by high-frequency roll-off and is not always able to support a high-order modulation on all the subcarriers of the channel. Since typically only a single modulation scheme is allowed in a conventional system, such a channel property may result in a same lower order modulation for the entire channel bandwidth or a higher order modulation with a reduced channel bandwidth, both preventing optimal usage of the channel.

In order to improve the capacity of the communication channel, adaptive modulation or adaptive bit loading over the channel is adopted, where the number of bits assigned to each subcarrier depends on the channel characteristic of that subcarrier. If a first subcarrier is with better channel characteristics than a second subcarrier, a larger number of bits are to be assigned to the first subcarrier accordingly. ITU G.996x/G.9991 includes such support, referred to here as adaptive bit-loading. However adaptive bit-loading is not defined in IEEE 802.11.

US2003120995A1 relates to a method for interleaving coded bits encoded at a prescribed code rate in a transmitter.

JP2000332618A aims to solve the problem of how to provide a transmitter capable of inserting a dummy bit in accordance with a used interleaver so that the position of the dummy bit in a compressed mode becomes optimum and a receiver capable of improving transmission quality by effect of the interleaver.

US2006188003A1 relates to a method for transmitting information including obtaining interference mitigation information associated with mitigating interference with a victim wireless device; and transmitting the interference mitigation information.

### SUMMARY OF THE INVENTION

For optical wireless communication, the channel may be limited by high-frequency roll-off, which is resulted from the characteristics of the optical components, such as an emitter and/or photodetector, in the system. In order to make a better use of the spectrum in the communication channel, the adaptive bit-loading in ITU G.996x/G.9991 uses a method based on a Bit Allocation Table (BAT) whereby bits are arranged in symbols which are then mapped onto IQ constellation points, and the modulation alphabet size depends on the number of bits mapped onto each tone. However, the BAT incurs high signalling overhead as it is not optimized for an optical communication system and thus provides more flexibility than what is required to handle the high frequency roll-off in an optical communication system, which thus compromises the benefits that are intended by the adaptive bit loading.

In contrast, IEEE 802.11 physical layers apply the same modulation scheme across all subcarriers, preventing an optimal usage of an OWC or LiFi channel. However, to improve the suitability of an IEEE 802.11 type of PHY for an OWC or LiFi system, it is necessary to add this feature, thereby potentially increasing the throughput. This invention describes an efficient method to facilitate adaptive bit-loading in an IEEE 802.11 type of PHY with a limited impact on the data packet generation process. The invention may however also be advantageously deployed in systems employing a packet generation process.

In view of the above, the present disclosure is directed to methods, apparatus, systems, computer program and computer-readable media for providing a mechanism to support an adaptive bit loading between a transmitter and receiver pair in a multi-carrier communication system. More particularly, the goal of this invention is achieved by a method of a transmitter as claimed in claim 1, by a method of a receiver as claimed in claim 9, by a transmitter as claimed in claim 10, by a receiver as claimed in claim 12, by a multi-carrier communication system in claim 14, and by a computer program as claimed in claim 15.

Accordingly, additional steps are carried out by the transmitter and the receiver to accommodate the adaptive bit loading in a standardized packet generation and reception procedure, which was originally designed and optimized for a system without support for adaptive bit loading.

In accordance with a first aspect of the invention a method for facilitating adaptive bit loading in a transmitter is provided. A method for facilitating adaptive bit loading in a transmitter of a multi-carrier communication system comprising a plurality of subcarriers, the method comprises the transmitter performing the steps of: determining an adaptive bit loading profile: wherein the adaptive bit loading profile defines for each one out of the plurality of subcarriers a corresponding constellation, and more than one constellation are to be used by the plurality of subcarriers: determining a size of an interleaving template table according to the highest order constellation of the determined adaptive bit loading profile: preparing data blocks by filling in data bits of an encoded data stream to the interleaving template table according to a predefined pre-processing pattern: wherein the predefined pre-processing pattern defines whether a cell in the interleaving template table is to be filled in either by a data bit of the encoded data stream or a dummy bit: carrying out an interleaving operation on the prepared data blocks: selecting bits from the interleaved data blocks according to a predefined selection pattern for mapping the selected bits to the more than one constellation of the plurality of subcarriers, wherein the predefined selection pattern corresponds to the predetermined pre-processing pattern such that a data bit is selected, and a dummy bit is discarded.

The multicarrier communication system may be based on wired communication or wireless communication. For wired systems, the operating channel may be placed at ‘baseband’ meaning that the operating frequency range starts from zero. In such cases, the multicarrier modulation may be referred to as Discrete Multitone (DMT). For wireless communication, the wireless channel may be located at different parts of the electromagnetic spectrums, such as radio frequency, microwave frequency, or the optical part, such as infrared, visible, or ultraviolet.

Adaptive modulation or adaptive bit loading is a method used to improve the channel capacity in a multi-carrier system by assigning the number of bits to each subcarrier depending on the channel characteristic of that subcarrier. However, this may lead to non-compliance with a standardized packet generation process, such as a vector-based processing with the assumption that a same modulation scheme is applied to all the subcarriers.

Interleaving is typically used in a communication system to convert convolutional codes from random error correctors to burst error correctors. By permutating adjacent coded bits to nonadjacent subcarriers, bursts of closely located errors are randomized, and enhancement for error corrections can then be applied. Thus, the main function performed by the interleaver at transmitter is to alter the input symbol sequence. At the receiver, the deinterleaver will revert this operation and alter the received sequence to get back the original unaltered sequence at the transmitter.

In a conventional system without support to adaptive bit loading, interleaving operates on the basis of a block of bits, the size of which is determined by a target modulation or target constellation to be used by the subcarriers. For example, in an Orthogonal Frequency Division Multiplexing (OFDM) based multicarrier system, all encoded data bits shall be interleaved by a block interleaver with a block size corresponding to the number of bits in a single OFDM symbol. The interleaver is defined by a two-step permutation. The first permutation causes adjacent coded bits to be mapped onto nonadjacent subcarriers. The second causes adjacent coded bits to be mapped alternately onto less and more significant bits of the constellation and long runs of low reliability (LSB) bits are avoided.

The operation of interleaving in a transmitter is implemented with the aid of an interleaving template table. The total number of cells in the interleaving template table is the same as the block size, which is determined by the number of data subcarriers in the system and the target constellation to be used by the subcarriers. Usually, the number of columns is determined according to the standard, such as defined by the permutation equation used for interleaving. And the number of rows is related to the target constellation. Note that the target constellation is assumed to be the same across all the subcarriers. Thus, in a practical system, vector-based signal processing is typically used to reduce the computation complexity of such an operation.

This invention aims to adapt such a vector-based signal processing process to accommodate adaptive bit loading without substantial change to the packet generation process. The highest order constellation of the adaptive bit loading profile is used to determine the size of the interleaving template table. And addition step is adopted to prepare data blocks by filling in data bits of an encoded data stream to the interleaving template table according to a predefined pre-processing pattern. The predefined pre-processing pattern defines whether a cell in the interleaving template table is to be filled in either by a data bit of the encoded data stream or a dummy bit. And then, a standard interleaving operation may be carried out on the data blocks. After the standard interleaving operation, it is necessary to select data bits and discard dummy bits, which is implemented with the aid of a predefined selection pattern. In this way, the interleaving may still be carried out in a vector-based approach to reduce the computation complexity.

Therefore, the interleaving template table are filled by the encoded data bits in such a manner that:
data blocks corresponding to the subcarriers with the highest order constellation are filled in with data bits only;
data blocks corresponding to the subcarriers with a lower order constellation, rather than the highest order constellation, are filled in with a mix of data bits and dummy bits according to the predefined pre-processing pattern.
   And then, data blocks corresponding to different subcarriers are of a uniform size.

It may also be the case that in the operation channel, one or more subcarriers are not able to carry any data bit, for example due to a degraded channel response or an interference, the corresponding one or more data blocks of those subcarriers may be filled in completely by dummy bits.

It should be understood that the step of filling a dummy bit in a certain cell of the interleaving template table may also be implemented by simply ignoring or skipping that cell, instead of actually storing a dummy bit in that cell.

Note that the predefined selection pattern corresponds to the predetermined pre-processing pattern: it is a mapping of the predetermined pre-processing pattern after the interleaver, which records the cell index that contains data to another cell index after the permutation operation. Therefore, although the pre-processing pattern may be defined in different ways, the predefined selection pattern is always determined according to the pre-processing pattern. Furthermore, different patterns may exhibit different levels of error performance and some therefore may make the selection by taking a particular channel response into account.

Beneficially, the predefined pre-processing pattern used by the transmitter is aligned with a receiver for establishing a multi-carrier communication link with adaptive bit loading.

The alignment may be made by applying a same rule in selecting the cells in the interleaving template table to store data bits. For example, when the highest order constellation is 64QAM, a default subset of six cells is used in constructing the table. For subcarriers with 16QAM, four out of six cells are used to store data bits. Similarly, for subcarriers with QPSK, two out of six cells are used to store data bits, and for BPSK only one out of six cells is used.

The alignment can be a simple agreement between the transmitter and the receiver on how to make such selection. It may be either the transmitter determines the pattern or the rule in defining the pattern and communicates it to the receiver, or the receiver determines it and communicates it to the transmitter. There may be a protocol on message exchange to ensure that a same pattern is adopted by both the transmitter and the receiver.

In a preferred setup, the multi-carrier communication system is according to an IEEE 802.11 standard.

Even more preferably, the multi-carrier communication system is an Orthogonal Frequency Division Multiplexing, OFDM, based system, such as an IEEE 802.11 system with an OFDM or OFDMA modulation.

Advantageously, the multi-carrier communication system is an optical wireless communication system.

As disclosed above, optical wireless communication (OWC) gained popularity in recent years. Different from other wireless communication channel, the channel response of an OWC channel may be dominated by one or more components in the signal propagation chain. One possible component can be the optical front end of the transmitter, such as a light-emitting diode (LED). The modulation bandwidth of commercially available LEDs is typically quite constrained as compared to the optical wireless communication spectrum. Due to the LEDs' dynamic response, or carrier recombination processes, a LED presents a power-limited first-order low-pass behavior, which may dominate the channel response of the optical communication channel. It is thus very efficient to make use of adaptive bit loading.

Given the maturity of the WLAN technology, it is beneficial to develop an OWC standard following the established IEEE 802.11 protocol with only limited changes. And then the majority part of the hardware, which is IEEE 802.11 compliant, may be reused.

In a preferred setup, the method further comprises the transmitter receiving from a receiver the adaptive bit loading profile.

As one option, the bit loading profile is determined by the receiver, such as based on one or more previously received data packets from the transmitter or based on a test packet from the transmitter. And then, the receiver may determine the bit loading profile according to a channel response derived from the one or more previously received data packets or the test packet.

Beneficially, the method further comprises the transmitter sending to another receiver a characteristic of the transmitter before determining the adaptive bit loading profile by the transmitter.

The adaptive bit loading profile may be derived based on knowledge of channel response, such as derived from characteristics of components in the communication chain. And then, it is beneficial that the transmitter informs the receiver about a characteristic of the transmitter before deriving the adaptive bit loading profile. The characteristic of the transmitter may be a constraint related to the performance of the optical front end, channel bandwidth, center frequency, maximum output power, and etc. Therefore, it is preferable that the transmitter sends such information to a remote receiver device in case either it is the remote receiver determines the adaptive bit loading profile and provides it to the transmitter, or it is the transmitter to determine the adaptive bit loading profile upon a feedback from the remote receiver.

Similarly, if a bi-directional link is to be established, both sides may negotiate the bit-loading profiles to be used in each direction, noting that the bit-loading profiles may be different in each direction. These negotiations may take into account the performance of the optical front end at each end of the link, the channel bandwidth, the center frequency, the signal-to-noise ratio of the channel and so on. The two sides may also conduct channel soundings to directly measure the channel characteristics. These may be conducted by transmission pseudo-random data over representative bit-loading profiles to determine the optimum balance between bit rate and error performance. Preferably, such sounding operations would be conducted at times of low traffic.

Negotiation between a transmitter and receiver may lead to an agreed bit loading profile to be used for all upcoming packets from then on. Alternatively, the negotiation is used to establish some boundaries, within which the actual bit loading profile is determined on a per-packet basis, such as adjusted according to a feedback from the receiver (e.g., ARQ or RSSI information or a different profile explicitly requested by the receiver).

Advantageously, the method is further comprises the transmitter compiling information related to the adaptive bit loading profile into a PHY header of a data packet to be sent by the transmitter via adaptive bit loading.

To inform a remote device about the usage of bit loading, a dedicated signalling packet may be used. Alternatively, such information may be piggy backed in the data packet to be sent. Preferably, the information is compiled in a compact format and put in the packet header. As one option, the information may be put in a dedicated field of the packet header, such as the SIGNAL field.

In one example, the method further comprising the transmitter reducing the amount of information compiled in the PHY header by making use of a known characteristic of a communication channel.

As addressed above, to facilitate adaptive bit loading between a transmitter and receiver pair may suffer an efficiency penalty resulting from the extra computation complexity and signaling overhead. It is thus desirable to simplify the signalling overhead by making use of known characteristics of the communication channel.

For example, an OWC channel typically exhibits a first order low-pass response. It may be sufficient to inform the intended receiving device of the highest constellation to be used, the corner frequency (such as the subcarrier index), and the slope (such as the number of subcarriers in a group sharing a same modulation index). Therefore, three parameters may be already adequate to describe the bit loading profile, instead of describing the bit loading profile on a per-subcarrier basis.

In accordance with a second aspect of the invention a method for facilitating adaptive bit loading in a receiver is provided. A method for facilitating adaptive bit loading in a receiver of a multi-carrier communication system comprising a plurality of subcarriers, the method comprises the receiver performing the steps of: determining an adaptive bit loading profile: wherein the adaptive bit loading profile defines for each one out of the plurality of subcarriers a corresponding constellation, and more than one constellation are to be used by the plurality of subcarriers: determining a size of a deinterleaving template table according to the highest order constellation of the determined adaptive bit loading profile: preparing data blocks by filling in data bits of a data stream from a constellation demapper to the deinterleaving template table according to a predefined selection pattern: wherein the predefined selection pattern defines whether a cell in the deinterleaving template table is to be filled in either by a data bit of the data stream or a dummy bit: carrying out a deinterleaving operation on the prepared data blocks: selecting bits from the deinterleaved data blocks according to a predefined pre-processing pattern for decoding the selected bits, wherein the predefined preprocessing pattern corresponds to the predetermined selection pattern such that a data bit is selected, and a dummy bit is discarded.

On the receiver side, a similar approach is taken to adapt a conventional packet reception procedure to facilitate an adaptive bit loading scheme. Additional steps are carried out before and after the standard deinterleaving operation for adding and removing dummy bits, respectively. Note that since deinterleaving is the reverse operation of interleaving, the predefined pre-processing pattern and the predefined selection pattern are used in a reversed order as compared to the transmitter side. The predefined selection pattern is used to add dummy bits in the deinterleaving template table, while the predefined preprocessing pattern is used to remove dummy bits.

The transmitter may be a mobile communication device and may also range from functionality comparable to either an access point or station as found in an IEEE 802.11 network.

In accordance with a third aspect of the invention a transmitter is provided. A transmitter for facilitating adaptive bit loading in a multi-carrier communication system comprising a plurality of subcarriers, the transmitter comprises: a processor configured to determine an adaptive bit loading profile: wherein the adaptive bit loading profile defines for each one out of the plurality of subcarriers a corresponding constellation, and more than one constellation are to be used by the plurality of subcarriers: determine a size of an interleaving template table according to the highest order constellation of the determined adaptive bit loading profile: a pre-processing unit configured to prepare data blocks by filling in data bits from an encoded data stream to the interleaving template table according to a predefined pre-processing pattern: wherein the predefined pre-processing pattern defines whether a cell in the interleaving template table is to be filled in either by a data bit from the encoded data stream or a dummy bit: an interleaving unit configured to carry out an interleaving operation on the prepared data blocks: a post-processing unit configured to select bits from the interleaved data blocks according to a predefined selection pattern for mapping the selected bits to the more than one constellation of the plurality of subcarriers, wherein the predefined selection pattern corresponds to the predetermined pre-processing pattern such that a data bit is selected, and a dummy bit is discarded.

In one example, the pre-processing unit and/or the post-processing unit is integrated in the interleaving unit.

Instead of being a separate unit, either the pre-processing unit or the post-processing unit, or both, may be integrated in the interleaving unit or the interleaver.

In accordance with a fourth aspect of the invention a receiver is provided. A receiver for facilitating adaptive bit loading in a multi-carrier communication system comprising a plurality of subcarriers, the receiver comprises: a processor configured to determine an adaptive bit loading profile: wherein the adaptive bit loading profile defines for each one out of the plurality of subcarriers a corresponding constellation, and more than one constellation are to be used by the plurality of subcarriers: determine a size of a deinterleaving template table according to the highest order constellation of the determined adaptive bit loading profile: a pre-processing unit configured to prepare data blocks by filling in data bits of a data stream from a constellation demapper to the deinterleaving template table according to a predefined selection pattern: wherein the predefined selection pattern defines whether a cell in the deinterleaving template table is to be filled in either by a data bit of the data stream or a dummy bit: a deinterleaving unit configured to carry out a deinterleaving operation on the prepared data blocks: a post-processing unit configured to select bits from the deinterleaved data blocks according to a predefined pre-processing pattern for decoding the selected bits, wherein the predefined pre-processing pattern corresponds to the predetermined selection pattern such that a data bit is selected, and a dummy bit is discarded.

In one setup the pre-processing unit and the post-processing unit are separate from the deinterleaving unit. And then, the deinterleaving unit may be a standard unit, the same as in another system without support for adaptive bit loading. The deinterleaving operation is implemented as if a single modulation scheme is applied to all the subcarriers.

Alternatively, the pre-processing unit and/or the post-processing unit is integrated in the deinterleaving unit.

Instead of being a separate unit, either the pre-processing unit or the post-processing unit, or both, may be integrated in the deinterleaving unit or the deinterleaver.

In accordance with a further aspect of the invention a multi-carrier wireless communication system is provided. A multi-carrier wireless communication system comprises: a transmitter according to the present invention; and a receiver according to the present invention: wherein the transmitter and the receiver are configured to set up a communication link with adaptive bit loading.

The invention may further be embodied in a computer program comprising code means which, when the program is executed by a transmitter comprising processing means, cause the processing means to carry out the method of the present invention.

The invention may further be embodied in a computer program comprising code means which, when the program is executed by a receiver comprising processing means, cause the processing means to carry out the method of the present invention.

### BRIEF DESCRIPTION OF THE DRAWINGS

In the drawings, like reference characters generally refer to the same parts throughout the different figures. Also, the drawings are not necessarily to scale, emphasis instead generally being placed upon illustrating the principles of the invention.

FIG. 1 demonstrates an exemplary subcarrier allocation according to IEEE 802.11a standard;

FIG. 2 demonstrates an example of bit loading profile applied to an exemplary subcarrier allocation according to IEEE 802.11a standard:

FIG. 3 schematically depicts basic components of a transmitter:

FIG. 4 schematically depicts basic components of a receiver:

FIG. 5 illustrates a multicarrier communication system:

FIG. 6 shows a flow diagram of a method to facilitating adaptive bit loading in a transmitter; and

FIG. 7 shows a flow diagram of a method to facilitating adaptive bit loading in a receiver.

### DETAILED DESCRIPTION OF EMBODIMENTS

The embodiments set forth below represent information to enable those skilled in the art to practice the embodiments and illustrate the best mode of practicing the embodiments. Upon reading the following description in light of the accompanying drawings, those skilled in the art will understand the concepts of the disclosure and will recognize applications of these concepts not particularly addressed herein. It should be understood that these concepts and applications fall within the scope of the disclosure.

The IEEE 802.11 standard comprises several different physical (PHY) layers operating under essentially a single medium access control (MAC) layer (albeit containing extensions that may be specific to one or more PHYs). PHYs of interest to the 802.11 TGbb technical group comprise, but not limited to, the OFDM PHY (clause 17 of IEEE 802.11-2020 standard, known as ‘IEEE 802.11a’) and the High Efficiency (HE) PHY (IEEE 802.11ax-2020 standard, known as ‘IEEE 802.11ax’).

One can trace a direct line of descendancy from IEEE 802.11a to IEEE 802.11ax via 802.11n (High Throughput (HT) PHY) and IEEE 802.11ac (Very High Throughput (VHT) PHY). A further PHY, 802.11be, is currently being proposed as a derivative of IEEE 802.11ax. While the descendant PHYs add important features including an increased number of subcarriers, multiple streams for multiple input multiple output (MIMO) operation, higher order subcarrier modulation, orthogonal frequency division multiple access (OFDMA), they all build on the PPDU generation process used by IEEE 802.11a. Since this invention adds bit-loading during this process, it will be described with reference to IEEE 802.11a on the understanding that it will be equally applicable (albeit on a different scale) to the current and future descendent PHYs. It will also be applicable to other OFDM-based PHYs that use a similar process to generate OFDM symbols from a data stream.

IEEE 802.11a was the first 802.11 PHY to use OFDM and 52 subcarriers in a 20 MHz bandwidth. Four subcarriers are pilot subcarriers, and the other 48 subcarriers are used for data transmission. Data to be sent on the subcarriers is processed and packaged into a PHY protocol data unit (PPDU) comprising a number of so-called OFDM symbols prior to transmission. By reversing this process, the receiver can recover the original bit stream.

OFDM subcarriers can be modulated with one of the following constellations: BPSK, QPSK, 16-QAM or 64-QAM, each carrying 1, 2, 4 or 6 bits per symbol respectively. Convolutional coding is applied at a coding rate of ½, meaning that, on average, 1 bit in every 2 carries data with the remainder carrying redundancy information or ¾, in which 3 bits in every 4 bits carry data. For 64-QAM, a coding rate of ⅔ is used instead of ½ to avoid duplication of a bit rate.

All data subcarriers are modulated with the same constellation and use the same coding rate, and all OFDM symbols in the data-carrying portion of the transmitted packet have the same format. These combinations result in data rates: 6, 9, 12, 18, 24, 36, 48, 54 Mbit/s.

The choice of different constellations and coding rates is provided to enable a trade-off between data throughput capacity and channel quality. In IEEE 802.11-2020 standard, the following specifications are provided for minimum receiver sensitivity and bit rate for the different constellations and different coding rates. The table below combines data from tables 17-4 and 17-18 from IEEE 802.11-2020 standard:

| | | Coded bits per | Coded bits per | Data bits per | | Rx minimum |
|---|---|---|---|---|---|---|
| | Coding | subcarrier | OFDM symbol | OFDM symbol | Data rate | input sensitivity |
| Modulation | rate | (N_{BPSC}) | (N_{CBPS}) | (N_{DBPS}) | (Mbit/s) | (dBm) |
| BPSK | 1/2 | 1 | 48 | 24 | 6 | −82 |
| BPSK | 3/4 | 1 | 48 | 36 | 9 | −81 |
| QPSK | 1/2 | 2 | 96 | 48 | 12 | −79 |
| QPSK | 3/4 | 2 | 96 | 72 | 18 | −77 |
| 16-QAM | 1/2 | 4 | 192 | 96 | 24 | −74 |
| 16-QAM | 3/4 | 4 | 192 | 144 | 36 | −70 |
| 64-QAM | 2/3 | 6 | 288 | 192 | 48 | −66 |
| 64-QAM | 3/4 | 6 | 288 | 216 | 54 | −65 |

As can be seen, receiver sensitivity for a given packet error rate varies considerably across the range of constellations. This enables an optimum constellation to be chosen to maximize the achievable throughput for a given RF channel.

In an OWC system or a LiFi system, the baseband signal, comprising the in-phase and quadrature (I and Q) components of the OFDM symbols, is modulated onto a relatively low-frequency carrier, which is then imposed onto the output of an LED, VCSEL or other suitable emitter, typically using intensity modulation. The challenge for OWC (and other systems that operate at a low carrier frequency with respect to the signal bandwidth) is that the frequency response of the channel comprising the transmitter, the air interface and the receiver typically has a low-pass response. For LiFi, this means that the system performance is limited by the high frequency performance of the emitter or, perhaps, by that of the optical receiver or even the combination. This means that the signal-to-noise ratio of the higher frequency carriers is typically less than that of the lower frequency carriers, in turn meaning that, in weak signal conditions, they will be the first to be lost to noise. In IEEE 802.11a, all subcarriers have the same modulation. Thus, the constellation (and coding rate) to be used will be dictated by the needs of the higher frequency subcarriers. Even if the carrier-to-noise ratio of the lower frequency carriers is high enough to support a higher rate, less robust constellation, they will be forced to use the same lower rate, more robust constellation needed by the higher frequency carriers and thus the effective throughput is reduced unnecessarily by this limitation.

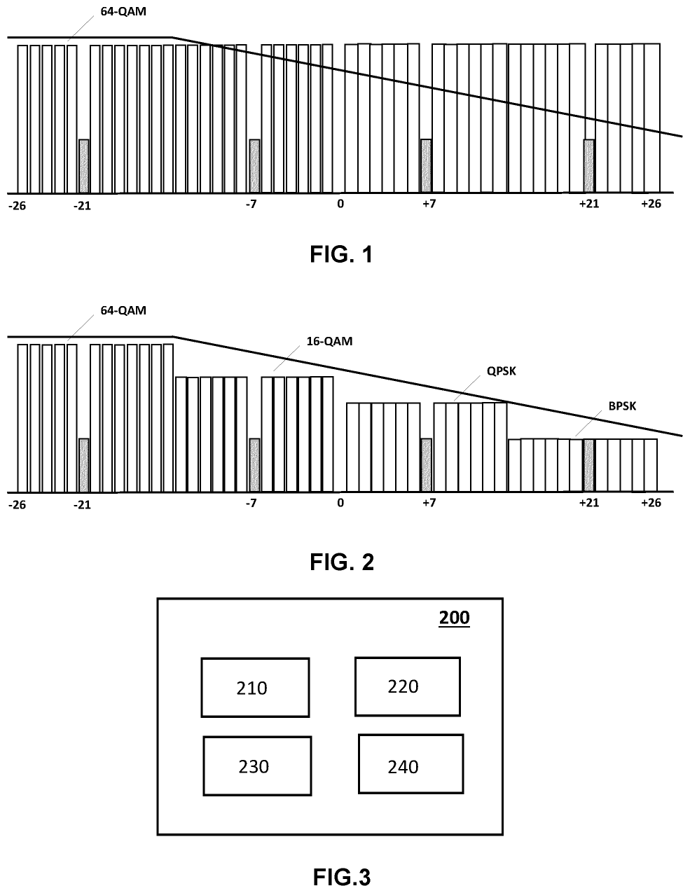

FIG. 1 demonstrates an exemplary subcarrier allocation according to IEEE 802.11a standard, where the height of the carriers is determined by the carrier-to-noise ratio required for good performance. The grey carriers at {−21, −7, +7, +21} are pilot carriers, which are BPSK-modulated by a pseudo-random sequence and carry no data. The other carriers are data carriers, modulated in this example with 64-QAM. There is no carrier at position 0. Superimposed on the carriers is a representation of the channel frequency response, as demonstrated by the solid line. The channel frequency response exhibits roll-off with increasing frequency, resulting in the majority of data carriers having insufficient carrier-to-noise to meet the required performance.

With the current state of the art, the only solution available is to use BPSK modulation for all carriers to ensure that even the high frequency carriers have sufficient carrier-to-noise ratio. However, a preferred way of sending data in this case would be to allow lower frequency carriers to use the higher order modulations (e.g., 16-QAM and 64-QAM) while higher frequency carriers use lower order modulations. This maximizes the potential of each carrier and thereby the system as a whole.

Adaptive bit-loading is an established technique by which subcarriers can be allocated different numbers of data bits to carry according to the signal-to-noise or signal-to-interference experienced by the receiver for each subcarrier. In ITU G.9960, for example, bit-loading is used to adjust the number of bits carried per carrier, or per group of carriers, in response to channel measurements conducted between sender and receiver.

This invention discloses modifications to the packet generation process that allow adaptive bit-loading to be applied to an OFDM specification that does not inherently support bit-loading. While the aim is to combat high frequency losses, the technique is generally applicable to other bit-loading requirements, such as mitigating frequency-specific losses or interference. While IEEE 802.11a is used as the example embodiment, the techniques described are equally applicable to other OFDM/OFDMA systems, in particular those descending from IEEE 802.11a. Methods of signalling are proposed, taking advantage of the relatively simple bit-loading needed for OWC or LiFi communication.

In IEEE 802.11a, a transmitted packet, or PPDU, comprises a few OFDM preamble symbols, followed by a symbol that indicates the constellation used for the subcarriers in the rest of the packet. The rest of the packet begins with more signalling information followed by an arbitrary number of OFDM symbols containing user data. The PPDU format is defined by FIG. 17-1 in IEEE 802.11-2020 standard, which shows the structure of the transmitted PPDU. A PPDU comprises a PHY preamble, a SIGNAL field of one OFDM symbol length, and a DATA field comprising variable number of OFDM symbols.

The process of generating the OFDM symbols for the DATA field follows a multi-step process:
1. Padder: Adds a number of pad bits to ensure that the DATA field is a multiple of the number of data bits per OFDM symbol. (See 17.3.5.4 of IEEE 802.11-2020 standard)
2. Data scrambler: Bits in the DATA field are scrambled to ‘whiten’ the data stream and prevent long sequences of 1's and 0's. (See 17.3.5.5 of IEEE 802.11-2020 standard)
3. Convolutional encoder: The scrambled data stream is then passed through a convolutional encoder that outputs two coded bits for every single bit input. This generates a coded stream of rate 1/2. The coded stream may then be ‘punctured’, that is, certain bits will be dropped in a methodical manner to generate streams with code rates of ⅔ and ¾. (See 17.3.5.6 of IEEE 802.11-2020 standard)
4. Interleaver: The coded bit stream is then divided up into blocks of 48 (BPSK), 96 (QPSK), 192 (16-QAM) or 288 (64-QAM) bits according to the constellation to be used with each subcarrier. Each block is then shuffled by an interleaver whose job it is to ensure that adjacent bits in the coded bitstream are sent on separated subcarriers. (See 17.3.5.7 of IEEE 802.11-2020 standard)
5. Subcarrier modulation mapper: The output of the interleaver is divided up into groups of bits of size 1 (BPSK), 2 (QPSK), 4 (16-QAM) or 6 (64-QAM). Each such group is mapped to a complex value according to the mapping defined for the constellation, with the complex values scaled to ensure that the mean power per OFDM symbol remains the same for all constellations. (See 17.3.5.8 of IEEE 802.11-2020 standard)
6. Pilot subcarriers: Into each group of 48 complex symbols, four pilot symbols are added. (See 17.3.5.9 of IEEE 802.11-2020 standard)
7. OFDM Modulation: Finally, an inverse fast Fourier transform (IFFT) is performed on the set of complex values and the resulting stream of samples sent for transmission. (See 17.3.5.10 of IEEE 802.11-2020 standard)

FIG. 2 demonstrates an example of a bit loading profile applied to an exemplary subcarrier allocation according to IEEE 802.11a standard. In general, with bit-loading, according to the channel response, some subcarriers carry fewer bits than others. The example profile is constructed as follows: of the 48 carriers, suppose the first 12 use 64-QAM, the next 12 16-QAM, the next 12 QPSK and the final 12 BPSK.

This enables an OFDM symbol to carry (288+192+96+48)/4=156 coded bits. When using a coding rate of ½, 78 data bits can be carried (or 104 bits for code rate 2/3 or 117 bits for ¾). By comparison, with BPSK on all carriers, it would be limited to 48 coded bits (or 24 data bits for code rate 1/2, 32 bits for ⅔ or 36 bits for ¾) so this bit-loading profile provides a significant improvement on performance. Of course, different profiles with different trade-offs are also possible.

Working forwards with this profile, we would pad the DATA field appropriately according to the coding rate and the bit-loading profile and operate scrambling and convolutional coding without change.

Working backwards, the IFFT operates without change regardless of bit-loading profile. The constellation mapper is to map complex values to the appropriate constellation for the carrier and therefore needs to know the bit-loading profile, but this is a minor change: per carrier, the mapping process is similar.

The tricky point is the interleaver. This operates on the assumption that all carriers carry the same number of bits and therefore shuffles a block of bits sized according to the constellation to be used. For example, when BPSK is used, the interleaver works with a block of 48 bits: one bit per carrier. For the other constellations, the interleaver works with 96 bits (QPSK), 192 bits (16-QAM) or 288 bits (64-QAM). This constraint means that it cannot readily be adapted to work with a block containing an arbitrary number of bits.

In this example, the interleaver works with four blocks of 288 bits. This invention incorporates bit-loading in a novel way by inserting an extra stage before the interleaver or as part of the interleaver itself that adds a number of dummy bits—in this case, 132 ((4*288/4)−156=132)—and inserts them into the block of 156, in a pattern such that the interleaver shuffles them into known places in the output so they can be dropped by the later stages.

There are a number of possible methods that can be categorized as follows.
1) Operate the chain from the interleaver onwards on a ‘per carrier’ or ‘per carrier group’ basis;
2) Use a special mapping that maps fewer bits to a subset of a higher order constellation.

Example methods will now be described with reference to the IEEE 802.11a transmitter noting that they may be readily adapted to the descendant standards 802.11n, IEEE 802.11ac, IEEE 802.11ax and 802.11be.

### Interleaving in IEEE 802.11a

The interleaving operation of IEEE 802.11a, described in 17.3.5.7 of IEEE 802.11-2020 standard, operates on a block of bits of size determined by the target modulation and comprises two stages. The first stage operates by reading successive bits into a table row-by-row and reading bits out by column. For 16-QAM and 64-QAM (and, in later chapters, for higher-order modulations 256-QAM and 1024-QAM), bits grouped together for output on the same subcarrier are shuffled to ensure that successive bits in the input stream are not all sent as LSBs.

The following table shows the interleaving operation for BPSK with the OFDM PHY. Since 48 subcarriers are each used to carry one bit of data per OFDM symbol, the interleaver operates with a block of 48 bits. These are read in from left to right, top to bottom. They are read out top to bottom, left to right. Thus, successive carriers, starting from the lowest in frequency to the highest, carry bits 0, 16, 32, 1, 17, 33, and so on.

| | | | | | | | | | | | | | | | |
|---|---|---|---|---|---|---|---|---|---|---|---|---|---|---|---|
| 0 | 1 | 2 | 3 | 4 | 5 | 6 | 7 | 8 | 9 | 10 | 11 | 12 | 13 | 14 | 15 |
| 16 | 17 | 18 | 19 | 20 | 21 | 22 | 23 | 24 | 25 | 26 | 27 | 28 | 29 | 30 | 31 |
| 32 | 33 | 34 | 35 | 36 | 37 | 38 | 39 | 40 | 41 | 42 | 43 | 44 | 45 | 46 | 47 |

As can be seen, each column carries the information for three subcarriers.

For QPSK, each subcarrier carries two bits and the interleaver operates on a block of 96 bits:

| | | | | | | | | | | | | | | | |
|---|---|---|---|---|---|---|---|---|---|---|---|---|---|---|---|
| 0 | 1 | 2 | 3 | 4 | 5 | 6 | 7 | 8 | 9 | 10 | 11 | 12 | 13 | 14 | 15 |
| 16 | 17 | 18 | 19 | 20 | 21 | 22 | 23 | 24 | 25 | 26 | 27 | 28 | 29 | 30 | 31 |
| 32 | 33 | 34 | 35 | 36 | 37 | 38 | 39 | 40 | 41 | 42 | 43 | 44 | 45 | 46 | 47 |
| 48 | 49 | 50 | 51 | 52 | 53 | 54 | 55 | 56 | 57 | 58 | 59 | 60 | 61 | 62 | 63 |
| 64 | 65 | 66 | 67 | 68 | 69 | 70 | 71 | 72 | 73 | 74 | 75 | 76 | 77 | 78 | 79 |
| 80 | 81 | 82 | 83 | 84 | 85 | 86 | 87 | 88 | 89 | 90 | 91 | 92 | 93 | 94 | 95 |

Bits are read in left to right, top to bottom as before. Now, they are read out in groups of two, where the first bit in each pair is sent to the I channel and the second to the Q channel: {0, 16}, {32, 48}, {64, 80}, {1, 17}, {33, 49} and so on.

Again, each column carries the information for three subcarriers.

For 16-QAM, each subcarrier carries four bits and the interleaver operates on a block of 192 bits:

| | | | | | | | | | | | | | | | |
|---|---|---|---|---|---|---|---|---|---|---|---|---|---|---|---|
| 0 | 1 | 2 | 3 | 4 | 5 | 6 | 7 | 8 | 9 | 10 | 11 | 12 | 13 | 14 | 15 |
| 16 | 17 | 18 | 19 | 20 | 21 | 22 | 23 | 24 | 25 | 26 | 27 | 28 | 29 | 30 | 31 |
| 32 | 33 | 34 | 35 | 36 | 37 | 38 | 39 | 40 | 41 | 42 | 43 | 44 | 45 | 46 | 47 |
| 48 | 49 | 50 | 51 | 52 | 53 | 54 | 55 | 56 | 57 | 58 | 59 | 60 | 61 | 62 | 63 |
| 64 | 65 | 66 | 67 | 68 | 69 | 70 | 71 | 72 | 73 | 74 | 75 | 76 | 77 | 78 | 79 |
| 80 | 81 | 82 | 83 | 84 | 85 | 86 | 87 | 88 | 89 | 90 | 91 | 92 | 93 | 94 | 95 |
| 96 | 97 | 98 | 99 | 100 | 101 | 102 | 103 | 104 | 105 | 106 | 107 | 108 | 109 | 110 | 111 |
| 112 | 113 | 114 | 115 | 116 | 117 | 118 | 119 | 120 | 121 | 122 | 123 | 124 | 125 | 126 | 127 |
| 128 | 129 | 130 | 131 | 132 | 133 | 134 | 135 | 136 | 137 | 138 | 139 | 140 | 141 | 142 | 143 |
| 144 | 145 | 146 | 147 | 148 | 149 | 150 | 151 | 152 | 153 | 154 | 155 | 156 | 157 | 158 | 159 |
| 160 | 161 | 162 | 163 | 164 | 165 | 166 | 167 | 168 | 169 | 170 | 171 | 172 | 173 | 174 | 175 |
| 176 | 177 | 178 | 179 | 180 | 181 | 182 | 183 | 184 | 185 | 186 | 187 | 188 | 189 | 190 | 191 |

Outgoing bits are now grouped into blocks of four with two bits each sent to the I and Q channels respectively, in order MSB down to LSB. Without the second stage, bits would be output as: {0, 16; 32, 48}, {64, 80; 96, 112}, {128, 144; 160, 176}, {1, 17; 33, 49}, {65, 81; 97, 113}, {129, 145; 161, 177} and so on. Successive input bits 16, 17, 18 and so on are all output as the LSB of the output symbols. To avoid this, the second stage of interleaving shuffles bits in every other column:

| | | | | | | | | | | | | | | | |
|---|---|---|---|---|---|---|---|---|---|---|---|---|---|---|---|
| 0 | 17 | 2 | 19 | 4 | 21 | 6 | 23 | 8 | 25 | 10 | 27 | 12 | 29 | 14 | 31 |
| 16 | 1 | 18 | 3 | 20 | 5 | 22 | 7 | 24 | 9 | 26 | 11 | 28 | 13 | 30 | 15 |
| 32 | 49 | 34 | 51 | 36 | 53 | 38 | 55 | 40 | 57 | 42 | 59 | 44 | 61 | 46 | 63 |
| 48 | 33 | 50 | 35 | 52 | 37 | 54 | 39 | 56 | 41 | 58 | 43 | 60 | 45 | 62 | 47 |
| 64 | 81 | 66 | 83 | 68 | 85 | 70 | 87 | 72 | 89 | 74 | 91 | 76 | 93 | 78 | 95 |
| 80 | 65 | 82 | 67 | 84 | 69 | 86 | 71 | 88 | 73 | 90 | 75 | 92 | 77 | 94 | 79 |
| 96 | 113 | 98 | 115 | 100 | 117 | 102 | 119 | 104 | 121 | 106 | 123 | 108 | 125 | 110 | 127 |
| 112 | 97 | 114 | 99 | 116 | 101 | 118 | 103 | 120 | 105 | 122 | 107 | 124 | 109 | 126 | 111 |
| 128 | 145 | 130 | 147 | 132 | 149 | 134 | 151 | 136 | 153 | 138 | 155 | 140 | 157 | 142 | 159 |
| 144 | 129 | 146 | 131 | 148 | 133 | 150 | 135 | 152 | 137 | 154 | 139 | 156 | 141 | 158 | 143 |
| 160 | 177 | 162 | 179 | 164 | 181 | 166 | 183 | 168 | 185 | 170 | 187 | 172 | 189 | 174 | 191 |
| 176 | 161 | 178 | 163 | 180 | 165 | 182 | 167 | 184 | 169 | 186 | 171 | 188 | 173 | 190 | 175 |

While the first three blocks on the output, sent to the first three subcarriers, are the same, the next three have their bits shuffled: {0, 16; 32, 48}, {64, 80; 96, 112}, {128, 144; 160, 176}, {17, 1; 49, 33}, {81, 65; 113, 97}, {145, 129; 177, 161}. The pattern repeats across the table.

For 64-QAM, each subcarrier carries six bits, three each in the I and Q channels. The second stage interleaving now operates over groups of three columns:

| | | | | | | | | | | | | | | | |
|---|---|---|---|---|---|---|---|---|---|---|---|---|---|---|---|
| 0 | 33 | 18 | 3 | 36 | 21 | 6 | 39 | 24 | 9 | 42 | 27 | 12 | 45 | 30 | 15 |
| 16 | 1 | 34 | 19 | 4 | 37 | 22 | 7 | 40 | 25 | 10 | 43 | 28 | 13 | 46 | 31 |
| 32 | 17 | 2 | 35 | 20 | 5 | 38 | 23 | 8 | 41 | 26 | 11 | 44 | 29 | 14 | 47 |
| 48 | 81 | 66 | 51 | 84 | 69 | 54 | 87 | 72 | 57 | 90 | 75 | 60 | 93 | 78 | 63 |
| 64 | 49 | 82 | 67 | 52 | 85 | 70 | 55 | 88 | 73 | 58 | 91 | 76 | 61 | 94 | 79 |
| 80 | 65 | 50 | 83 | 68 | 53 | 86 | 71 | 56 | 89 | 74 | 59 | 92 | 77 | 62 | 95 |
| 96 | 129 | 114 | 99 | 132 | 117 | 102 | 135 | 120 | 105 | 138 | 123 | 108 | 141 | 126 | 111 |
| 112 | 97 | 130 | 115 | 100 | 133 | 118 | 103 | 136 | 121 | 106 | 139 | 124 | 109 | 142 | 127 |
| 128 | 113 | 98 | 131 | 116 | 101 | 134 | 119 | 104 | 137 | 122 | 107 | 140 | 125 | 110 | 143 |
| 144 | 177 | 162 | 147 | 180 | 165 | 150 | 183 | 168 | 153 | 186 | 171 | 156 | 189 | 174 | 159 |
| 160 | 145 | 178 | 163 | 148 | 181 | 166 | 151 | 184 | 169 | 154 | 187 | 172 | 157 | 190 | 175 |
| 176 | 161 | 146 | 179 | 164 | 149 | 182 | 167 | 152 | 185 | 170 | 155 | 188 | 173 | 158 | 191 |
| 192 | 225 | 210 | 195 | 228 | 213 | 198 | 231 | 216 | 201 | 234 | 219 | 204 | 237 | 222 | 207 |
| 208 | 193 | 226 | 211 | 196 | 229 | 214 | 199 | 232 | 217 | 202 | 235 | 220 | 205 | 238 | 223 |
| 224 | 209 | 194 | 227 | 212 | 197 | 230 | 215 | 200 | 233 | 218 | 203 | 236 | 221 | 206 | 239 |
| 240 | 273 | 258 | 243 | 276 | 261 | 246 | 279 | 264 | 249 | 282 | 267 | 252 | 285 | 270 | 255 |
| 256 | 241 | 274 | 259 | 244 | 277 | 262 | 247 | 280 | 265 | 250 | 283 | 268 | 253 | 286 | 271 |
| 272 | 257 | 242 | 275 | 260 | 245 | 278 | 263 | 248 | 281 | 266 | 251 | 284 | 269 | 254 | 287 |

Similar tables can be drawn up for the HT PHY (IEEE 802.11n, chapter 19), the VHT PHY (IEEE 802.11ac, chapter 21) and the HE PHY (IEEE 802.11ax, chapter 27). The table dimensions differ because of the different numbers of carriers used and the use of 256-QAM and 1024-QAM.

The later PHYs also support MIMO, meaning that multiple ‘channels’ or spatial streams are generated and transmitted simultaneously. Interleaving is performed separately for each stream with an extra ‘frequency rotation’ stage that essentially performs a two-dimensional rotation on the table after stage 2 interleaving. Each stream is rotated by a different constant, which is determined by the stream number and the table dimensions. For stream 0, no such rotation is performed.

### Adaptive Bit-Loading for LiFi

For adaptive bit-loading for LiFi, we need to pay attention to the columns towards the right of the table because these carry data for the higher frequency carriers, which for LiFi, are the carriers most at risk. Instead of sending information pertaining to six bits per subcarrier, we may prefer to send four, two or even just one bit.

This invention discloses a method that can be used to achieve this without substantial change of the PPDU creation process. This will be described with reference to the transmitter: similar changes are expected at the receiver.

We note that, no matter which modulation is used, each column of the interleaving table contains data for three subcarriers and, thus, we have 18 rows for 64-QAM, 12 for 16-QAM, 6 for QPSK and 3 for BPSK. Thus, for IEEE 802.11a, the most natural approach is to select modulation modes in groups of three subcarriers.

To implement adaptive bit-loading, we form an interleaving table according to the highest modulation mode in use and then select a subset of bits for transmission from each column.

For subcarriers using 64-QAM, operation proceeds as normal. For subcarriers not using 64-QAM, a subset of six bits is selected. For instance, for 16-QAM, four bits from six are selected, for QPSK, two from six are chosen and, for BPSK, a single bit is chosen. The remaining bits are discarded.

It will be apparent that the selection of bits can be made in different ways and one selection pattern is shown below. A cell with a bolded number inside indicates a place to store a data bit.

| 64QAM | | | | 16QAM | | | | QPSK | | | | BPSK | | | |
|---|---|---|---|---|---|---|---|---|---|---|---|---|---|---|---|
| 0 | 33 | 18 | 3 | 36 | 21 | 6 | 39 | 24 | 9 | 42 | 27 | 12 | 45 | 30 | 15 |
| 16 | 1 | 34 | 19 | 4 | 37 | 22 | 7 | 40 | 25 | 10 | 43 | 28 | 13 | 46 | 31 |
| 32 | 17 | 2 | 35 | 20 | 5 | 38 | 23 | 8 | 41 | 26 | 11 | 44 | 29 | 14 | 47 |
| 48 | 81 | 66 | 51 | 84 | 69 | 54 | 87 | 72 | 57 | 90 | 75 | 60 | 93 | 78 | 63 |
| 64 | 49 | 82 | 67 | 52 | 85 | 70 | 55 | 88 | 73 | 58 | 91 | 76 | 61 | 94 | 79 |
| 80 | 65 | 50 | 83 | 68 | 53 | 86 | 71 | 56 | 89 | 74 | 59 | 92 | 77 | 62 | 95 |
| 96 | 129 | 114 | 99 | 132 | 117 | 102 | 135 | 120 | 105 | 138 | 123 | 108 | 141 | 126 | 111 |
| 112 | 97 | 130 | 115 | 100 | 133 | 118 | 103 | 136 | 121 | 106 | 139 | 124 | 109 | 142 | 127 |
| 128 | 113 | 98 | 131 | 116 | 101 | 134 | 119 | 104 | 137 | 122 | 107 | 140 | 125 | 110 | 143 |
| 144 | 177 | 162 | 147 | 180 | 165 | 150 | 183 | 168 | 153 | 186 | 171 | 156 | 189 | 174 | 159 |
| 160 | 145 | 178 | 163 | 148 | 181 | 166 | 151 | 184 | 169 | 154 | 187 | 172 | 157 | 190 | 175 |
| 176 | 161 | 146 | 179 | 164 | 149 | 182 | 167 | 152 | 185 | 170 | 155 | 188 | 173 | 158 | 191 |
| 192 | 225 | 210 | 195 | 228 | 213 | 198 | 231 | 216 | 201 | 234 | 219 | 204 | 237 | 222 | 207 |
| 208 | 193 | 226 | 211 | 196 | 229 | 214 | 199 | 232 | 217 | 202 | 235 | 220 | 205 | 238 | 223 |
| 224 | 209 | 194 | 227 | 212 | 197 | 230 | 215 | 200 | 233 | 218 | 203 | 236 | 221 | 206 | 239 |
| 240 | 273 | 258 | 243 | 276 | 261 | 246 | 279 | 264 | 249 | 282 | 267 | 252 | 285 | 270 | 255 |
| 256 | 241 | 274 | 259 | 244 | 277 | 262 | 247 | 280 | 265 | 250 | 283 | 268 | 253 | 286 | 271 |
| 272 | 257 | 242 | 275 | 260 | 245 | 278 | 263 | 248 | 281 | 266 | 251 | 284 | 269 | 254 | 287 |

Different selection patterns may exhibit different levels of error performance and some therefore may prove advantageous in the low pass channels considered for LiFi.

The adaptive bit-loading process can operate in a number of ways:
1) An interleaving table is set up with the number of rows established by the highest order constellation used. Bits from the convolutional encoder are interspersed with dummy bits according to a pre-determined pattern. This can be done:
   a. by an ‘adaptive bit-loader mapper’ stage installed between the convolutional encoder and the interleaver;
   b. by the interleaver itself.
2) The first interleaving stage operates as normal.
3) The second interleaving stage operates:
   a. Across the whole table according to the highest order constellation used;
   b. On a per-column basis according to the constellation used for that column.
4) Either:
   a. The constellation mapper selects bits from the output of the interleaver in accordance with the predetermined pattern such that coded bits are selected and dummy bits discarded.
   b. The interleaver outputs a stream of coded bits with dummy bits discarded: the constellation mapper takes bits as necessary for each subcarrier in turn.

The choice of process may depend on the changes that need to be made to an existing implementation. In the a) cases, there is no change to the interleaver block, and a new adaptive bit-loader mapper stage is inserted between the output of the convolutional encoder and the interleaver. In the b) cases, the interleaver is also aware of the bit-loading profile and can adapt its operation accordingly. In all cases, the constellation mapper must be aware of the bit-loading profile in use and the form of the output of the interleaver.

Practical implementations may be a mix of the a) and b) options but, since the output of the second interleaving stage depends on which option is chosen, there must be common agreement among all stations that interoperate as to which option is used and which selection pattern is used.

Note that, although the OFDM subcarriers are now using different constellations, the code rate is determined by the puncturing in step 3 and cannot be changed on a per carrier basis.

At the receiver, similar processes happen in reverse. The demapper stage determines the bits modulated onto each carrier according to the adaptive bit-loading profile in operation, the groups of bits are combined with, if necessary, dummy bits inserted, the deinterleaver operates either as normal or on a ‘per column’ basis according to the profile in operation while a new ‘depadder’ block removes bits deemed to be padding bits according to the bit-loading profile in use. The resultant recovered 156-bit block is then added to the stream of bits fed in the convolutional decoder.

This process can be scaled to the requirements of different systems because the descendent standards 802.11n, IEEE 802.11ac and IEEE 802.11ax of IEEE 802.11a use the same interleaving mechanism scaled for the different numbers of subcarriers and constellations that the later standards support. Therefore, the same approach of inserting dummy bits can be used to affect a form of bit-loading.

Note that, while this example is targeted at bit-loading for low-pass roll-off, the dummy insertion method can, in principle, be used for other bit-loading strategies, like the handling of frequency or regulatory nulls, which may also be implemented via a similar template-based approach.

Carriers with No Bits

In some cases, it may be determined that carriers at the extreme high end are too weak to carry any bits at all. In this case, any bits loaded onto such carriers should be dummy bits, preferably generated by a pseudo-random noise-like sequence.

Ideally, such carriers would be switched off to save power at the transmitter. A compromise might be to use a high-order modulation (e.g., 64-QAM) and arrange the dummy bits such that the four 64-QAM symbols closest to zero are used. For 64-QAM, these would be the symbols {110 110, 010 110, 010 010, 110 010}. With higher-order modulations, like 256-QAM and higher, the energy spent on such ‘zero’ carriers is minimized.

### Signalling Use of Bit Loading

Low-pass roll-off applications have the advantage that the requirements are simpler and therefore the signalling can be simplified. For example, signalling the highest constellation to be used, the corner frequency (as carrier number) and the slope (as carrier group size) allows the bit-loading to be specified as {6, −13, 13} for our example above, taking into account the carrier numbering system used for IEEE 802.11a and the four pilot carriers interspersed within the 48 data carriers. This can be interpreted as, “Start by carrying 6 bits per carrier (i.e., 64-QAM) from carrier −26; at carrier −13, switch down to 16-QAM; thereafter switch down every 13th carrier until BPSK is reached.

It should be noted that the slope of a low-pass filter is generally specified in terms of db/octave or dB/decade. A 1st order lowpass filter has a slope of 6 db/octave, meaning that the gain drops by 6 dB for every doubling of frequency, or, equivalently, 20 dB/decade. This means that the slope within a fixed channel bandwidth (in the case of IEEE 802.11a, 20 MHz) is severest for the channel closest to or on the breakpoint. For higher frequency channels, while the average gain is less, the slope across the channel is also less and, therefore, mild slopes may be appropriate for these channels.

### Some Other Examples

{6, +17, 3} indicates a profile that is flat for most of the band, beginning with 64-QAM but which drops off rapidly at the high end, with the last three carriers using BPSK;
{6, +17, 9} indicates a profile that is flat for most of the band beginning with 64-QAM but which uses 16-QAM for the last few carriers;
{4, −9, 18} suggests a relatively poor channel with a mild slope starting with 16-QAM but ending in BPSK;
{4, −9, 9} suggests a relatively poor channel with a steeper slope that begins with 16-QAM but ends in carriers that carry no bits.

For the third parameter, it may be preferred to have this refer to the number of data carriers, with pilot carriers being skipped automatically—this matches better with the interleaving table.

Since great precision is not required, it might be sufficient to specify the corner frequency in steps of three, six or twelve carriers and to specify the slope as 1st or 2nd order, or even fix it as one or the other. Thus, a sufficiently flexible bit-loading scheme for low-pass roll-off compensation could be specified in no more than 5 bits and even as little as 2 bits.

In some cases, the corner frequency may be outside of the current operating channel. And then, the highest operating frequency may be represented as the corner frequency, indicating a same constellation used in the current operating channel.

The approach specified assumes that the channel performance rolls off monotonically and thus models a low-pass response. This can result in some bearers carrying no bits, as can be seen in one of the examples. It may be preferred to use a shelf response instead in which the lowest modulation to be used is specified as a fourth parameter. Thus, as an alternative to the last example, we could have:
{4, −9, 9, 1} to indicate the use of 16-QAM from carriers −26 to −10, QPSK from −9 to 0 and BPSK from thereon.

In practice, a small number of curves may be sufficient to handle the cases most likely to occur. This can enable some spare capacity in the existing signalling structure of IEEE 802.11a to be utilized. Although such changes are not backwards compatible, LiFi has the potential advantage of novelty and, therefore, there is no legacy to be compatible with.

FIG. 3 schematically depicts basic components of a transmitter 200. The transmitter comprises a processor 210, a pre-processing unit 220, an interleaving unit 230, and a post-processing unit 240. The processor 210 is configured to derive an adaptive bit loading profile and determine a size of an interleaving template table according to the highest order constellation of the adaptive bit loading profile. The interleaving unit 230 may be a standard interleaver. The pre-processing unit 220 and the post-processing unit 240 are customized for adaptive bit loading.

Alternatively, the pre-processing unit 220 and/or the post-processing unit 240 may be integrated in the interleaving unit 230.

A SIGNAL field bit assignment is defined by FIG. 17-5 of IEEE 802.11-2020 standard.

| RATE (4-bit) | | | | | LENGTH (12-bit) | | | | | | | | | | | | | SIGNAL TAIL (6-bit) | | | | | |
|---|---|---|---|---|---|---|---|---|---|---|---|---|---|---|---|---|---|---|---|---|---|---|---|
| R1 | R2 | R3 | R4 | R | LSB MSB | | | | | | | | | | | | P | “0” | “0” | “0” | “0” | “0” | “0” |
| 0 | 1 | 2 | 3 | 4 | 5 | 6 | 7 | 8 | 9 | 10 | 11 | 12 | 13 | 14 | 15 | 16 | 17 | 18 | 19 | 20 | 21 | 22 | 23 |

In the IEEE 802.11a PPDU, the SIGNAL field is always sent using the robust BPSK ½ mode and indicates the modulation to be used by the rest of the PPDU. The signalling rate is set by the bits R1 to R4. Since only eight modulation/coding modes are used, eight combinations are available to indicate modulation/coding/bit-loading profile to be used by the rest of the field. An alternative, or additional, measure is to use the R bit to indicate the use of adaptive bit-loading. This may also be used to indicate the use of adaptive bit-loading for the descendent PHYs, that use the IEEE 802.11a header for compatibility but which set the RATE field to 6 Mbit/s.

An illustrative set of profiles is shown in the table below.

| | Modulation | | Bit-loading |
|---|---|---|---|
| R1-R4 | and coding | R1-R4 | profile |
| 1101 | BPSK, 1/2 | 1100 | {2, 0, 26}, 1/2 |
| 1111 | BPSK, 3/4 | 1110 | {2, 0, 26}, 3/4 |
| 0101 | QPSK, 1/2 | 0100 | {4, −9. 16}, 1/2 |
| 0111 | QPSK, 3/4 | 0110 | {4, −9, 16}, 3/4 |
| 1001 | 16-QAM, 1/2 | 1000 | {6, −13, 13}, 1/2 |
| 1011 | 16-QAM, 3/4 | 1010 | {6, −13, 13}, 3/4 |
| 0001 | 64-QAM, 2/3 | 0000 | {6, −9, 16}, 1/2 |
| 0011 | 64-QAM, 3/4 | 0010 | {6, −9, 16}, 3/4 |

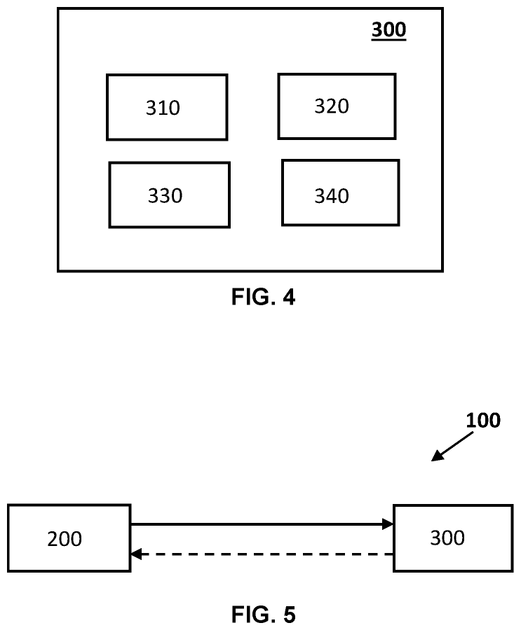

FIG. 4 schematically depicts basic components of a receiver 300. The receiver 300 comprises a processor 310, a pre-processing unit 320, a deinterleaving unit 330, and a post-processing unit 340. The processor 310 is configured to determine an adaptive bit loading profile and determine a size of a deinterleaving template table according to the highest order constellation of the adaptive bit loading profile. The deinterleaving unit 330 may be a standard deinterleaver. The pre-processing unit 320 and the post-processing unit 340 are customized for adaptive bit loading.

Alternatively, the pre-processing unit 320 and/or the post-processing unit 340 may be integrated in the deinterleaving unit 330.

FIG. 5 illustrates a multicarrier communication system 100. The multicarrier communication system comprises the transmitter 200 and the receiver 300 according to the present invention. Preferably, the multicarrier communication system is according to an IEEE 802.11 standard. Beneficially, the multicarrier communication system is an OWC system, and the transmitter and the receiver are configured to carry out OWC, such as LiFi communication.

### Negotiating Bit-Loading Parameters

Prior to the establishment of an active link, the two sides may negotiate the bit-loading parameters to be used in each direction, noting that the parameters may be different in each direction. These negotiations may take into account the performance of the optical front end at each end of the link, the channel bandwidth, the channel center frequency, the signal-to-noise ratio of the channel and so on.

The two sides may also conduct channel soundings to directly measure the performance of the channel. These may be conducted using pseudo-random data over representative bit-loading profiles to determine the optimum balance between bit rate and error performance. Preferably, such soundings would be conducted at times of low traffic. The soundings can be transmitter-led, wherein the transmitter sends sounding packets using profiles chosen by itself, adjusting the profiles according to results reported by the receiver. Alternatively, they can be receiver-led, in which the receiver requests a sample transmission using a bit-loading profile chosen by the receiver.

Similarly, the two sides can negotiate by either having the transmitter to indicate the bit-loading profile it intends to use, perhaps based on its knowledge of its own optical front-end performance, or by having the receiver indicate which profile it prefers to use to receive, perhaps based on factors like received signal strength and so on. Negotiations may, of course, also take into account factors like transmission power.

Since it is possible for the transmitter to indicate in each transmitted PPDU the bit-loading profile used for that PPDU, there is also a scope to change the profile on a per-PPDU basis if the performance of the link changes for any reason. Such a change might be triggered by a loss of PPDU acknowledgements from the receiver or a request from the receiver to change the profile in use.

### Extending to Multiuser Systems Such as 11ax

As mentioned previously, the proposed method for preparing the data can be extended from single user (SU) to multiuser (MU) systems using OFDMA such as IEEE 802.11ax. As stated in 27.3.12.8 (BCC interleavers) of IEEE 802.11ax-2020 standard, “the operation of the interleaver is described only for the SU case. For user u of an MU transmission, the interleaver operates in the same way on the output bits for that user. That is, the operation of the interleaver is the same as if the transmission were an SU one, consisting of bits from only that user.”

This follows in part because RUs can only take a few sizes.

According to section 27.3.12.8 of IEEE 802.11ax-2020 standard, “The BCC interleaver operation is specified in 21.3.10.8 (BCC interleaver). The interleaver parameters, NCOL, NROW, and NROT, for the Data field depend on the RU size and whether or not DCM is used and are defined in the RU size column of Table 27-35 (BCC interleaver parameters).” In other words, the dimensions of the interleaving table will change (and so will the adaptive bit-loading patterns) but the basic operations are the same.

The focus of this disclosure is to adapt IEEE 802.11 PHYs for OWC or LiFi, but the method could be applied to any physical layer based on OFDM/OFDMA and can benefit any communications medium with a well-defined (or measurable, if channel sounding is used) channel frequency response.

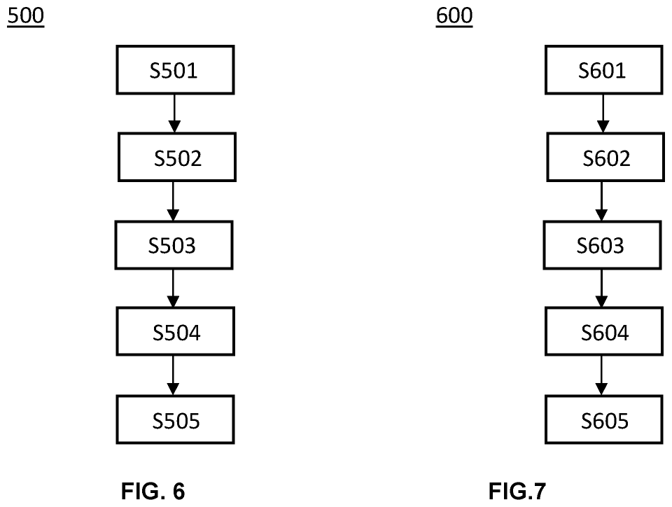

FIG. 6 shows a flow diagram of a method 500 to facilitate adaptive bit loading in a transmitter 200. A method (500) for facilitating adaptive bit loading in a transmitter 200 of a multi-carrier communication system 100, the method 500 comprises the transmitter 200: in step S501, deriving an adaptive bit loading profile: in step S502, determining a size of an interleaving template table according to the highest order constellation of the adaptive bit loading profile: in step S503, preparing data blocks by filling in data bits of an encoded data stream to the interleaving template table according to a predefined pre-processing pattern; wherein the predefined pre-processing pattern defines a cell in the interleaving template table is to be filled in either by a data bit of the encoded data stream or a dummy bit: in step S504, carrying out an interleaving operation on the data blocks: in step S505, selecting bits from the interleaved data blocks according to a predefined selection pattern, wherein the predefined selection pattern is corresponding to the predetermined pre-processing pattern such that a data bit is selected, and a dummy bit is discarded.

FIG. 7 shows a flow diagram of a method 600 to facilitate adaptive bit loading in a receiver 300. A method 600 for facilitating adaptive bit loading in a receiver 300 of a multi-carrier communication system 100, the method 600 comprises the receiver 300: determining in step S601 an adaptive bit loading profile: determining in step S602 a size of a deinterleaving template table according to the highest order constellation of the adaptive bit loading profile: in step S603, preparing data blocks by filling in data bits of a data stream from a constellation demapper to the deinterleaving template table according to a predefined selection pattern: wherein the predefined selection pattern defines a cell in the deinterleaving template table is to be filled in either by a data bit of the data stream or a dummy bit: in step S604, carrying out a deinterleaving operation on the data blocks: in step S605, selecting bits from the deinterleaved data blocks according to a predefined pre-processing pattern, wherein the predefined pre-processing pattern is corresponding to the predetermined selection pattern such that a data bit is selected, and a dummy bit is discarded.

The methods according to the invention may be implemented on a computer as a computer implemented method, or in dedicated hardware, or in a combination of both.

Executable code for a method according to the invention may be stored on computer/machine readable storage means. Examples of computer/machine readable storage means include non-volatile memory devices, optical storage medium/devices, solid-state media, integrated circuits, servers, etc. Preferably, the computer program product comprises non-transitory program code means stored on a computer readable medium for performing a method according to the invention when said program product is executed on a computer.

Methods, systems, and computer-readable media (transitory and non-transitory) may also be provided to implement selected aspects of the above-described embodiments.

The term “controller” is used herein generally to describe various apparatus relating to, among other functions, the operation of one or more network devices or coordinators. A controller can be implemented in numerous ways (e.g., such as with dedicated hardware) to perform various functions discussed herein. A “processor” is one example of a controller which employs one or more microprocessors that may be programmed using software (e.g., microcode) to perform various functions discussed herein. A controller may be implemented with or without employing a processor, and also may be implemented as a combination of dedicated hardware to perform some functions and a processor (e.g., one or more programmed microprocessors and associated circuitry) to perform other functions. Examples of controller components that may be employed in various embodiments of the present disclosure include, but are not limited to, conventional microprocessors, application specific integrated circuits (ASICs), and field-programmable gate arrays (FPGAs).

In various implementations, a processor or controller may be associated with one or more storage media (generically referred to herein as “memory,” e.g., volatile and non-volatile computer memory such as RAM, PROM, EPROM, and EEPROM, compact disks, optical disks, etc.). In some implementations, the storage media may be encoded with one or more programs that, when executed on one or more processors and/or controllers, perform at least some of the functions discussed herein. Various storage media may be fixed within a processor or controller or may be transportable, such that the one or more programs stored thereon can be loaded into a processor or controller so as to implement various aspects of the present invention discussed herein. The terms “program” or “computer program” are used herein in a generic sense to refer to any type of computer code (e.g., software or microcode) that can be employed to program one or more processors or controllers.

1. A method for facilitating adaptive bit loading in a transmitter of a multi-carrier communication system comprising a plurality of subcarriers, the method comprising the transmitter:
determining an adaptive bit loading profile; wherein the adaptive bit loading profile defines for each one out of the plurality of subcarriers a corresponding constellation, and more than one constellation are to be used by the plurality of subcarriers;
determining a size of an interleaving template table according to the highest order constellation of the determined adaptive bit loading profile; wherein the number of rows of the interleaving template table is determined by a number of data bits carried in a symbol of the highest order constellation, assuming that the highest order constellation is used by all the subcarriers;
preparing data blocks by filling in data bits of an encoded data stream to the interleaving template table according to a predefined pre-processing pattern; wherein the predefined pre-processing pattern defines whether a cell in the interleaving template table is to be filled in either by a data bit of the encoded data stream or a dummy bit, and data blocks corresponding to the subcarriers with the highest order constellation are filled in with data bits only and data blocks corresponding to the subcarriers with a lower order constellation, rather than the highest order constellation, are filled in with a mix of data bits and dummy bits according to the predefined pre-processing pattern;
carrying out an interleaving operation on the prepared data blocks; and
selecting bits from the interleaved data blocks according to a predefined selection pattern to map the selected bits to the more than one constellation of the plurality of subcarriers, wherein the predefined selection pattern corresponds to the predetermined pre-processing pattern such that a data bit is selected, and a dummy bit is discarded.

2. The method of claim 1, wherein the predefined pre-processing pattern used by the transmitter is aligned with a receiver for establishing a multi-carrier communication link with adaptive bit loading.

3. The method according to claim 1, wherein the multi-carrier communication system is according to an IEEE 802.11 standard.

4. The method according to claim 1, wherein the multi-carrier communication system is an optical wireless communication system.

5. The method according to claim 1 further comprising the transmitter receiving from a receiver the adaptive bit loading profile.

6. The method according to claim 1 further comprising the transmitter sending to another receiver a characteristic of the transmitter before determining the adaptive bit loading profile by the transmitter.

7. The method according to claim 1 further comprising the transmitter compiling information related to the adaptive bit loading profile in a PHY header of a data packet to be sent by the transmitter via adaptive bit loading.

8. The method according to claim 7, further comprising the transmitter reducing the amount of information compiled in the PHY header by making use of a known characteristic of a communication channel.

9. A method for facilitating adaptive bit loading in a receiver of a multi-carrier communication system comprising a plurality of subcarriers, the method comprising the receiver:
determining an adaptive bit loading profile; wherein the adaptive bit loading profile defines for each one out of the plurality of subcarriers a corresponding constellation, and more than one constellation are to be used by the plurality of subcarriers;
determining a size of a deinterleaving template table according to the highest order constellation of the determined adaptive bit loading profile; wherein the number of rows of the deinterleaving template table is determined by a number of data bits carried in a symbol of the highest order constellation, assuming that the highest order constellation is used by all the subcarriers;
preparing data blocks by filling in data bits of a data stream from a constellation demapper to the deinterleaving template table according to a predefined selection pattern; wherein the predefined selection pattern defines whether a cell in the deinterleaving template table is to be filled in either by a data bit of the data stream or a dummy bit, and data blocks corresponding to the subcarriers with the highest order constellation are filled in with data bits only and data blocks corresponding to the subcarriers with a lower order constellation, rather than the highest order constellation, are filled in with a mix of data bits and dummy bits according to the predefined selection pattern;
carrying out a deinterleaving operation on the prepared data blocks; and
selecting bits from the deinterleaved data blocks according to a predefined pre-processing pattern for decoding the selected bits, wherein the predefined pre-processing pattern corresponds to the predetermined selection pattern such that a data bit is selected, and a dummy bit is discarded.

10. A transmitter for facilitating adaptive bit loading in a multi-carrier communication system comprising a plurality of subcarriers, the transmitter comprising:
a processor configured to:
determine an adaptive bit loading profile; wherein the adaptive bit loading profile defines for each one out of the plurality of subcarriers a corresponding constellation, and more than one constellation are to be used by the plurality of subcarriers; and
determine a size of an interleaving template table according to the highest order constellation of the determined adaptive bit loading profile; wherein the number of rows of the interleaving template table is determined by a number of data bits carried in a symbol of the highest order constellation, assuming that the highest order constellation is used by all the subcarriers;
a pre-processing unit configured to prepare data blocks by filling in data bits from an encoded data stream to the interleaving template table according to a predefined pre-processing pattern; wherein the predefined pre-processing pattern defines whether a cell in the interleaving template table is to be filled in either by a data bit from the encoded data stream or a dummy bit, and data blocks corresponding to the subcarriers with the highest order constellation are filled in with data bits only and data blocks corresponding to the subcarriers with a lower order constellation, rather than the highest order constellation, are filled in with a mix of data bits and dummy bits according to the predefined pre-processing pattern;
an interleaving unit configured to carrying out an interleaving operation on the prepared data blocks; and
a post-processing unit configured to select bits from the interleaved data blocks according to a predefined selection pattern to map the selected bits to the more than one constellation of the plurality of subcarriers, wherein the predefined selection pattern corresponds to the predetermined pre-processing pattern such that a data bit is selected, and a dummy bit is discarded.

11. The transmitter according to claim 10, wherein the pre-processing unit and/or the post-processing unit is integrated in the interleaving unit.

12. A receiver for facilitating adaptive bit loading in a multi-carrier communication system comprising a plurality of subcarriers, the receiver comprising:
a processor configured to:
determine an adaptive bit loading profile; wherein the adaptive bit loading profile defines for each one out of the plurality of subcarriers a corresponding constellation, and more than one constellation are to be used by the plurality of subcarriers; and
determine a size of a deinterleaving template table according to the highest order constellation of the determined adaptive bit loading profile; wherein the number of rows of the deinterleaving template table is determined by a number of data bits carried in a symbol of the highest order constellation, assuming that the highest order constellation is used by all the subcarriers;
a pre-processing unit configured to prepare data blocks by filling in data bits of a data stream from a constellation demapper to the deinterleaving template table according to a predefined selection pattern; wherein the predefined selection pattern defines whether a cell in the deinterleaving template table is to be filled in either by a data bit of the data stream or a dummy bit, and data blocks corresponding to the subcarriers with the highest order constellation are filled in with data bits only and data blocks corresponding to the subcarriers with a lower order constellation, rather than the highest order constellation, are filled in with a mix of data bits and dummy bits according to the predefined selection pattern;
a deinterleaving unit configured to carrying out a deinterleaving operation on the prepared data blocks; and
a post-processing unit configured to select bits from the deinterleaved data blocks according to a predefined pre-processing pattern for decoding the selected bits, wherein the predefined pre-processing pattern corresponds to the predetermined selection pattern such that a data bit is selected, and a dummy bit is discarded.

13. The receiver according to claim 12, wherein the pre-processing unit and/or the post-processing unit is integrated in the deinterleaving unit.

14. A multi-carrier communication system comprising:
a transmitter according to claim 10; and
a receiver;
wherein the transmitter and the receiver are configured to set up a communication link with adaptive bit loading.

15. A non-transitory computer readable medium comprising instructions which, when the instructions are executed by
a transmitter cause the transmitter to perform the method of claim 1.

16. A non-transitory computer readable medium comprising instructions which, when the instructions are executed by a receiver cause the receiver to perform the method of claim 9.
